(19) United States
(12) Patent Application Publication
(10) Pub. No.: US 2010/0173012 A1
(43) Pub. Date: Jul. 8, 2010

(54) METHODS FOR TREATING AN APPLE TREE INFECTED WITH VENTURIA INAEQUALIS

(76) Inventors: Frances Trail, Mason, MI (US); Russell J. Rodriguez, Seattle, WA (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/630,244

(22) Filed: Dec. 3, 2009

Related U.S. Application Data
(60) Provisional application No. 61/120,310, filed on Dec. 5, 2008.

(51) Int. Cl. A01N 59/16; A01N 59/06; A01P 3/00

(52) U.S. Cl. 424/641; 424/646; 424/682

(57) ABSTRACT

A method of treating an apple orchard to reduce infection of the apple orchard by Venturia inaequalis by administering EARTHTEC® or a derivative of EARTHTEC®. A method of reducing sporulation of V. inaequalis by administering EARTHTEC® or a derivative of EARTHTEC®. A method of reducing the dispersal of ascospores from V. inaequalis-infected apple debris in orchards by administering EARTHTEC® or a derivative of EARTHTEC®.

This application claims benefit of provisional application Ser. No. 61/120,310, filed Dec. 5, 2008, entitled Methods For Treating An Apple Tree Infected With Venturia Inaequalis, the entire contents of which are incorporated herein in their entirety.

### FIELD OF THE INVENTION

This invention is in the field of agriculture and plant pathology and relates to treatment of an apple orchard that is infected with Venturia inaequalis.

### BACKGROUND OF THE INVENTION

The majority of fungal pathogens of plants fall into the group of Ascomycota. These fungi produce their spores in linear sacs called asci (ascus, singular). These sacs are designed to stretch up to the mouth of the flask or cup-shaped fruiting body, and fire their ascospores into the air like miniature water cannons. The airborne spores then infect the young leaves, flowers and fruit.

For many plant diseases, the initial inoculum is discharged from fruiting bodies residing in debris from the previous season's crop. Ascospores initiate apple scab in the spring and are formed in infected leaves on the ground. The lesions generated by ascospores will yield secondary spores (conidia) that begin the secondary inoculum, which increases disease levels through the spring and summer. This causes logarithmic increases in disease and requires farmers to spray fungicides every time it rains (which can be more than a dozen times throughout the season).

### SUMMARY OF THE INVENTION

The present invention includes a method of using EARTHTEC®, or an EARTHTEC®-based derivative to reduce the dispersal of ascospores from Venturia inaequalis-infected apple debris (e.g., leaves). This method can be use to effectively block the cyclic recurrence of V. inaequalis infection initiated by forcible inoculum dispersal.

### DETAILED DESCRIPTION OF THE PREFERRED EMBODIMENTS

Before the subject invention is described further, it is to be understood that the invention is not limited to the particular embodiments of the invention described below. It is also to be understood that the terminology employed is for the purpose of describing particular embodiments, and is not intended to be limiting.

All references, patents, publications, articles, databases, and other writings referred to in this application are incorporated herein by reference in their entirety, as if each were specifically and individually incorporated herein by reference. Such patents, publications, articles, databases, and other writings are incorporated for the purpose of describing and disclosing the subject components of the invention that are described in those patents, publications, articles, databases, and other writings which components might be used in connection with the presently described invention. The information provided below is not admitted to be prior art to the present invention, but is provided solely to assist the understanding of the reader.

The details of one or more embodiments of the invention are set forth in the description below. The preferred embodiments of the present invention may be understood more readily by reference to the following detailed description of the specific embodiments and the Examples included hereafter.

Unless defined otherwise, all technical and scientific terms used herein have the meaning commonly understood by one of ordinary skill in the art to which this invention belongs. Although any methods, devices and materials similar or equivalent to those described herein can be used in the practice or testing of the invention, the preferred methods, devices and materials are now described.

In this specification and the appended claims, the singular forms “a,” “an” and “the” include plural reference unless the context clearly dictates otherwise.

“An effective amount to reduce infection of an apple orchard by Venturia inaequalis” means there is a decrease in the amount of V. inaequalis infection in an apple orchard treated with EARTHTEC® or an EARTHTEC®-based derivative compound (described hereinbelow) as compared to the amount of V. inaequalis infection an untreated apple orchard. The decrease in the amount of V. inaequalis infection can be a reduction of V. inaequalis infection of 5%, 10%, 20%, 30%, 40%, 50%, 60%, 70%, 80%, 90%, 95%, 96%, 97%, 98%, 99%, or 100% in the treated as compared to the untreated orchard. The amount of V. inaequalis infection in the treated and untreated orchards can be determined by methods that are known by those skilled in the field of agriculture and plant pathology.

“An effective amount to reduce sporulation of the Venturia inaequalis” means there is a decrease in the amount of sporulation in treated V. inaequalis (treated with EARTHTEC® or an EARTHTEC®-based derivative compound described hereinbelow) as compared to the amount of sporulation in untreated V. inaequalis. The decrease in the amount of V. inaequalis sporulation can be a reduction of V. inaequalis sporulation of 5%, 10%, 20%, 30%, 40%, 50%, 60%, 70%, 80%, 90%, 95%, 96%, 97%, 98%, 99%, or 100% in the treated as compared to the untreated V. inaequalis. The amount of sporulation can be assayed by the methods described in the Examples hereinbelow and in other ways known in the field.

“An effective amount to reduce ascospore discharge of the Venturia inaequalis” means there is a decrease in the amount ascospore discharge in treated V. inaequalis (treated with EARTHTEC® or an EARTHTEC®-based derivative compound described hereinbelow) as compared to the amount ascospore discharge in untreated V. inaequalis. The decrease in the amount of ascospore discharge of V. inaequalis can be a reduction of ascospore discharge of V. inaequalis of 5%, 10%, 20%, 30%, 40%, 50%, 60%, 70%, 80%, 90%, 95%, 96%, 97%, 98%, 99%, or 100% in the treated as compared to the untreated V. inaequalis. The amount of ascospore discharged can be assayed by the methods described in the Examples hereinbelow and in other ways known in the field.

The mechanism of forcible ascospore discharge has been investigated in the wheat head blight fungus, Fusarium graminearum. Specifically, the inventors previously discovered that an influx of potassium and chloride ions into the ascus drives an influx of water. As the ascus engorges, it stretches up and bursts, discharging spores into the air. The inventors previously identified several ion channel inhibitors that inhibited discharge of ascospores in F. graminearum.

Because the ion-influx, water-influx spore discharge mechanism might be conserved among the ascomycetous fungi (which include many major plant pathogens), the inventors conceived of using ion channel inhibitors to reduce or prevent discharge of ascospores in V. inaequalis. The inventors identified three compounds that could be tested as ion channel inhibitors to reduce or prevent discharge of ascospores in V. inaequalis. These compounds, referred to herein as EARTHTEC®-based derivatives, are derivatives of a copper-based product called EARTHTEC® (EPA No.: 64962-1, MSDS Version 4.704, Earth Science Laboratories, Inc.), and are available from Earth Science Laboratories, Inc. The copper molecule used in the EARTHTEC® product is copper sulfate pentahydrate. The EARTHTEC® product encloses a Cu²⁺ ion in a chemical cage, which prevents the Cu²⁺ from association with anions (such anions otherwise would reduce efficacy). In three exemplary EARTHTEC®-based derivative compounds used in the present inventive method, the copper ion is substituted with Mg²⁺, Zn²⁺or Fe²⁺, each of which ions has less environmental toxicity than the Cu²⁺ion.

The method of present invention utilizes EARTHTEC®, or an EARTHTEC®-based derivative compound in which the EARTHTEC® product has been derivatized so that Cu²⁺ is substituted with a divalent cation, e.g., Mg²⁺, Zn²⁺ or Fe². In one embodiment of the present invention, the EARTHTEC® product is derivatized so that Cu²⁺ is substituted with Mg²⁺ or Zn²⁺ (“Earthtec-Mg” or “Earthtec-Zn”, respectively). The data for such Mg²⁺-based and Zn²⁺-based derivative compounds is presented in Table 1 and Table 2 (See, Example 3 hereinbelow).

The methods of the present invention can be used to treat an apple tree (or an apple orchard) to reduce or prevent infection by V. inaequalis, or to reduce or prevent sporulation of Venturia inaequalis, for example, by reducing or preventing ascospore discharge by V. inaequalis. With these methods, any of the aforedescribed EARTHTEC® or EARTHTEC®-based derivatives could be administered or dispersed, e.g., by spraying, onto apple tree debris to reduce or prevent sporulation of V. inaequalis. The treatment could be applied in any season. In one embodiment, the treatment is applied in the spring. As a protectant or for prevention of infection, the application could occur just prior to bud break in the spring. Continued applications could be performed throughout the spring and in the fall after leaf-drop in heavy infestations. In one embodiment, in the spring, the apple tree debris is sprayed on fruiting bodies or ascospores on leaves on the ground in an apple orchard (the leaves are from the previous season's crop).

The exact dosage, exposure time, and frequency of administration of the aforedescribed EARTHTEC® or EARTHTEC®-based derivative compounds depends on the which of the compounds is used, the severity of the infection being treated, the age, size, and general condition of the particular tree(s), and other treatments in use for the tree(s). In one of the Examples below, the leaf was exposed to a 10% solution of the EARTHTEC®-based derivative compound for 10 minutes (time-limited by blotting and rinsing); resulting in complete inhibition of ascospore discharge. A lower concentration of an EARTHTEC® or EARTHTEC®-based derivative compound also could be effective in inhibiting ascospore discharge if the exposure time of the EARTHTEC® or EARTHTEC®-based derivative compound to the leaf is increased, e.g., the EARTHTEC® or EARTHTEC®-based derivative compound is allowed to remain on the leaf such as by eliminating blotting and/or rinsing (see Example 2 below).

In another embodiment, the concentration of the EARTHTEC® or EARTHTEC®-based derivative compound can be reduced as access of the compound to the fruiting body is increased. For example, because ascospores are dispersed from the tips of the fruiting bodies which emerge from the leaf, a reduced concentration could be used if the compound is permitted to remain on the leaf as the fruiting bodies emerge from the leaf.

With respect to variations in the treatment methods as described herein, the effectiveness of the treatment can be determined using the assay methods described below in the Examples, and in other ways known in the art.

In one embodiment of the present method, the schedule of dosing could include applying a treatment weekly prior to and during ascospore dissemination periods in the spring. Dosage concentrations for each treatment could be in the range of 100 to 60,000 ppm, in the range of 300 to 30,000 ppm, in the range of 500 to 10,000 pp, or in the range of 1000 to 5,000 ppm. Also, the EARTHTEC® or EARTHTEC®-based derivative compound can be applied until the leaf surfaces are visibly damp.

The exposure time of the EARTHTEC® or EARTHTEC®-based derivative compound on the apple tree debris or live plant could vary from minutes to days, e.g., 1 min., 5 min., 10 min., 30 min., 1 hour, 2 hour, 5 hour, 10 hour, 12 hour, 24 hour, or 48 hour exposure time. Alternatively, the EARTHTEC® or EARTHTEC®-based derivative compound could be allowed to remain indefinitely on the apple tree debris or live plant, or until the EARTHTEC® or EARTHTEC®-based derivative compound is removed from the apple tree debris or live plant by rain or other naturally occurring phenomena.

In the present method, compositions for administration to the apple debris will commonly comprise one or more of the aforedescribed EARTHTEC® or EARTHTEC®-based derivative (as the active agent) dissolved in an acceptable carrier, preferably an aqueous carrier. A variety of aqueous carriers can be used. Adjuvants that increase wettability such as sodium dodecyl sulfate, Triton-Z—100 and other detergents could be used. These solutions are preferably free of undesirable matter. The compositions may also contain auxiliary substances as required, such as pH adjusting and buffering agents, toxicity adjusting agents and the like. The concentration of active agent in these formulations can vary widely, and will be selected primarily based on fluid volumes, viscosities, tree(s) or orchard size and the like in accordance with the particular mode of administration selected.

In another method of the present invention, the aforedescribed EARTHTEC® or EARTHTEC®-based derivative could be dispersed on living plants (e.g., apple trees) to reduce or prevent infection, ascospore discharge, or sporulation of V. inaequalis. The timing, exposure time, schedule, and range/amount of dosing can be adjusted as described above.

In one embodiment, the EARTHTEC®-based derivative compound selected is nontoxic and, therefore, useful in organically growing apples.

Having now generally described the invention, the same will be more readily understood through reference to the following Examples, which are provided by way of illustration, and are not intended to be limiting of the present invention, unless specified.

### EXAMPLES

### Example 1

### Test Compounds

Ten compounds were tested for their ability to reduce or prevent ascospore discharge in V. inaequalis. The inventors had previously successfully used seven of these compounds with F. graminearum (Tolazamide, glyburide, BAPTA, verapamil, glycerol, mannitol, TMB8). The three EARTHTEC®-based derivative compounds identified hereinabove were similarly tested. These three compounds, however, had not been tested on F. graminearum.

Four additives also were tested to decrease nonspecific adsorption and to increase uptake: 10% Dimethylsulfoxide, 0.05% Tween 60, 0.05% Sodium dodecyl sulfate, and Polyvinylpyrrolidone. The additives were tested in association with the ten compounds to try to enhance their efficacy.

### Example 2

### Methods

Assays were performed on 1 cm diameter disks removed from infected leaves collected in the spring from orchards at Michigan State University and apple trees in the Lansing, Mich. area. Initially, variation in spore release from disk to disk was too high to perform reliable comparisons between treated and control samples. To overcome this limitation, the inventors excised leaf disks that contained fairly uniform distributions of pseudothecia, and cut each disk in half. One half-disk was used for treatment, the other half was used as a control (usually water plus a surfactant). This set-up provided consistent and uniform tissue to test in a comparative manner. If the control half-disk did not release spores, then the treated half-disk was not included in the data.

Leaf disks were treated by soaking for 10 minutes in a 10% solution of the EARTHTEC®-Mg or EARTHTEC®-Zn derivative compounds identified hereinabove, followed by blotting briefly, and then rinsed briefly in water. In another protocol, the blotting step or rinse steps were eliminated.

Disks were then placed on the lid of a petri dish above a glass coverslip in a moist chamber. Spores were deposited on a glass coverslip after a 24 hr incubation. Coverslips were removed and spores quantified under a microscope. Only the two-celled spores characteristic of V. inaequalis were quantified.

### Example 3

### Results

None of the seven compounds previously shown to be effective in reducing ascospore discharge in F. graminearum were similarly effective in inhibiting ascospore discharge in V. inaequalis.

Table 1 shows the number of ascospores released from leaf-disk halves treated with Earthtec-Mg in comparison to control leaf-disk halves. Circular disks were removed from leaves and cut in half. Half was soaked in Earthtec-Mg, and half was soaked in water (control). “n.d.” means no ascospores were detected.

As shown in Table 1, Earthtec-Mg arrested ascospore discharge (and no ascospores leave the pseudothecium). Moreover, repeated wetting after the application did not result in renewal of discharge activity (data not shown). Also, when a 0.5% solution (300 ppm) of the EARTHTEC®-Mg derivative compound was applied and the blotting or rinse steps eliminated, ascospore discharge was completely inhibited (data not shown). Further, the additives identified in Example 1 above were used with no effect on efficacy.

TABLE 1

| Trial 1 | | Trial 2 | | Trial 3 | |
|---|---|---|---|---|---|
| Control | Treatment | Control | Treatment | Control | Treatment |
| 157 | n.d. | 292 | n.d. | 0 | n.d. |
| 676 | n.d. | 244 | n.d. | 622 | n.d. |
| 428 | n.d. | 25 | n.d. | 635 | n.d. |
| 670 | n.d. | 50 | n.d. | 131 | n.d. |

Table 2 shows the number of ascospores released from leaf-disk halves treated with Earthtec-Zn in comparison to control leaf-disk halves. Circular disks were removed from leaves and cut in half. Half was soaked in Earthtec-Zn, and half was soaked in water (control). As shown in Table 2, Earthtec-Zn arrested ascospore discharge.

TABLE 2

Trial 1

| Rep | Control | Treatment |
|---|---|---|
| 1 | 350 | n.d. |
| 2 | 479 | n.d. |
| 3 | 143 | n.d. |

While the foregoing specification has been described with regard to certain preferred embodiments, and many details have been set forth for the purpose of illustration, it will be apparent to those skilled in the art that the invention may be subject to various modifications and additional embodiments, and that certain of the details described herein can be varied considerably without departing from the spirit and scope of the invention.

What is claimed is:

1. A method of treating an apple orchard to reduce infection of the apple orchard by Venturia inaequalis comprising administering to the apple orchard an effective amount of a compound selected from the group consisting of EARTHTEC® and EARTHTEC®-based derivatives, wherein the EARTHTEC®-based derivatives are EARTHTEC® compounds in which the copper has been substituted with a divalent cation.

2. The method of claim 1 wherein the divalent cation is selected from the group consisting of Mg²⁺, Zn²⁺, and Fe²⁺.

3. The method of claim 2 wherein the divalent cation is Mg²⁺.

4. The method of claim 2 wherein the divalent cation is Zn²⁺.

5. The method of claim 1 wherein the apple orchard further comprises apple tree debris and the compound is administered to the apple tree debris.

6. The method of claim 5 wherein the administering of the compound is by spraying the compound on the apple tree debris.

7. A method of reducing sporulation of Venturia inaequalis comprising administering to V. inaequalis an effective amount of a compound selected from the group consisting of EARTHTEC® and EARTHTEC®-based derivatives, wherein the EARTHTEC®-based derivatives are EARTHTEC® compounds in which the copper has been substituted with a divalent cation.

8. The method of claim 7 wherein the administering of the compound to the V. inaequalis reduces ascospore discharge from the V. inaequalis.

9. The method of claim 7 wherein the divalent cation is selected from the group consisting of Mg²⁺, Zn²⁺, and Fe²⁺.

10. The method of claim 9 wherein the divalent cation is Mg²⁺.

11. The method of claim 9 wherein the divalent cation is Zn²⁺.

12. The method of claim 7 wherein the V. inaequalis resides on apple tree debris and the compound is administered to the apple tree debris.
